(19) United States
(12) Patent Application Publication
(10) Pub. No.: US 2012/0204536 A1
(43) Pub. Date: Aug. 16, 2012

(54) CATALYTIC CONVERTER COMBUSTION STRATEGY FOR A HYBRID VEHICLE

(75) Inventors: Eugene V. Gonze, Pinckney, MI (US); Bryan Nathaniel Roos, West Bloomfield, MI (US); Halim G. Santoso, Novi, MI (US); Brian L. Spohn, Holly, MI (US)

(73) Assignee: GM GLOBAL TECHNOLOGY OPERATIONS LLC, Detroit, MI (US)

(21) Appl. No.: 13/024,462

(22) Filed: Feb. 10, 2011

(51) Int. Cl. F02G 5/04

(52) U.S. Cl. 60/273; 180/65.27

(57) ABSTRACT

A method of operating a hybrid vehicle when an internal combustion engine is not running includes heating a flow of air flowing through an exhaust gas treatment system of the internal combustion engine that is supplied by an air pump with a heating module and a hydrocarbon injector. The heating module heats an electrically heated catalyst of the exhaust gas treatment system in preparation for starting the internal combustion engine. Additionally, thermal energy is recovered from the flow of air downstream of the electrically heated catalyst and transferred to at least one other vehicle system to provide thermal energy to the vehicle system, such as an engine coolant for a cabin heating system or a transmission fluid for a drivetrain transmission system.

### TECHNICAL FIELD

The invention generally relates to a method of operating a hybrid vehicle, and more specifically a method of heating a vehicle system with thermal energy from an exhaust gas treatment system for an internal combustion engine of the hybrid vehicle.

### BACKGROUND

Vehicles with an Internal Combustion Engine (ICE) include an exhaust gas treatment system for reducing the toxicity of the exhaust gas from the engine. The treatment system typically includes a close coupled catalytic converter and an underfloor catalytic converter, each of which includes a catalyst that reduces nitrogen oxides in the exhaust gas to nitrogen and carbon dioxide or water, as well as oxidizes carbon monoxide (CO) and unburnt hydrocarbons (HCs) to carbon dioxide and water. The catalyst may include, but is not limited to, Platinum Group Metals (PGM). The catalyst must be heated to a light-off temperature of the catalyst before the catalyst becomes operational. Accordingly, the exhaust gas must heat the catalyst to the light-off temperature before the reaction between the catalyst and the exhaust gas begins.

Some vehicles may include an exhaust gas heater, such as but not limited to an electric heating module, to further heat the exhaust gas to reduce the time to heat the catalyst to the light-off temperature. In conventional vehicles that are only powered by the internal combustion engine, the exhaust gas heater is limited to heating the exhaust gas only after the engine is started, i.e., post crank heating. In hybrid vehicles that further include an ICE/electric motor combination for powering the vehicle, the hybrid vehicle may power the exhaust gas heater prior to starting the engine, i.e., pre-crank heating, thereby further increasing the amount of heat transferred to the exhaust gas and reducing the time to heat the catalyst to the light-off temperature.

Additionally, some vehicles may include a hydrocarbon injector, which injects hydrocarbons, e.g., gasoline or diesel fuel, into the flow of exhaust gas upstream of the underfloor catalytic converter. The hydrocarbons combust to further add heat to the flow of exhaust gas, which decreases the time to bring the catalyst up to the light-off temperature.

In addition to the catalyst in the close coupled catalytic converter and the underfloor catalytic converter, other vehicle systems must be heated in order to operate properly and/or more efficiently. For example, energy losses within a drivetrain transmission system are considerably higher when a transmission fluid, i.e., oil, is cold. Heating the transmission fluid decreases the energy losses within the drivetrain transmission system, making the drivetrain transmission system more energy efficient. Also, a cabin heating system draws thermal energy from an engine coolant for the internal combustion engine. In hybrid vehicles, when the internal combustion engine is not required to power the hybrid vehicle, a considerable amount of fuel may be consumed to otherwise run the internal combustion engine to heat the engine coolant for the cabin heating system, thereby decreasing the overall fuel efficiency of the hybrid vehicle.

### SUMMARY

A method of heating a vehicle system with thermal energy from an exhaust gas treatment system for an internal combustion engine is provided. The method includes heating an electrically heated catalyst with a heating module to a pre-determined temperature. A flow of air is pumped through the exhaust gas treatment system after the electrically heated catalyst is heated to the pre-defined temperature to transfer heat from the heating module to the flow of air. Hydrocarbons are injected into the flow of air after the electrically heated catalyst is heated to the pre-defined temperature to form a hydrocarbon/air mixture. The hydrocarbon/air mixture is combusted upstream of a underfloor catalyst to heat the flow of air. Thermal energy is recovered from the flow of air downstream of the underfloor catalyst with an exhaust gas heat recovery system. The method further includes transferring the recovered thermal energy to a vehicle system to provide heat to the vehicle system.

A method of operating a hybrid vehicle is also provided. The method includes determining if an internal combustion engine of the hybrid vehicle is running, or if the internal combustion engine is not running. A electrically heated catalyst of an exhaust gas treatment system is heated with a heating module to a pre-determined temperature when the internal combustion engine is not running. A flow of air is pumped through the exhaust gas treatment system with an air pump after the electrically heated catalyst is heated to the pre-defined temperature to transfer heat from the heating module to the flow of air when the internal combustion engine is not running. Hydrocarbons are injected into the flow of air after the electrically heated catalyst is heated to the pre-defined temperature to form a hydrocarbon/air mixture when the internal combustion engine is not running. The hydrocarbon/air mixture is combusted upstream of a underfloor catalyst of the exhaust gas treatment system to heat the flow of air when the internal combustion engine is not running. Thermal energy from the flow of air is recovered downstream of the underfloor catalyst with an exhaust gas heat recovery system. The method further includes transferring the recovered thermal energy to an engine coolant of a cabin heating system or a transmission fluid of a drivetrain transmission system.

Accordingly, the heating module heats the electrically heated catalyst to the light-off temperature prior to the internal combustion engine being started, thereby preparing the exhaust gas treatment system for operation at peak performance. Additionally, the heating module in combination with combustion of the injected hydrocarbons may further heat the flow of air from the air pump. The excess heat generated while heating the electrically heated catalyst to the light off temperature and combusting the injected hydrocarbons is recovered and transferred to at least one other vehicle system, including but not limited to the engine coolant of the cabin heating system or the transmission fluid of the drivetrain transmission system, to reduce energy losses and/or reduce fuel usage of the hybrid vehicle.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of an exhaust gas treatment system for an internal combustion engine of a vehicle.

FIG. 2 is a flow chart showing a method of operating a hybrid vehicle to heat a vehicle system with thermal energy from an exhaust gas treatment system for an internal combustion engine of the vehicle.

### DETAILED DESCRIPTION

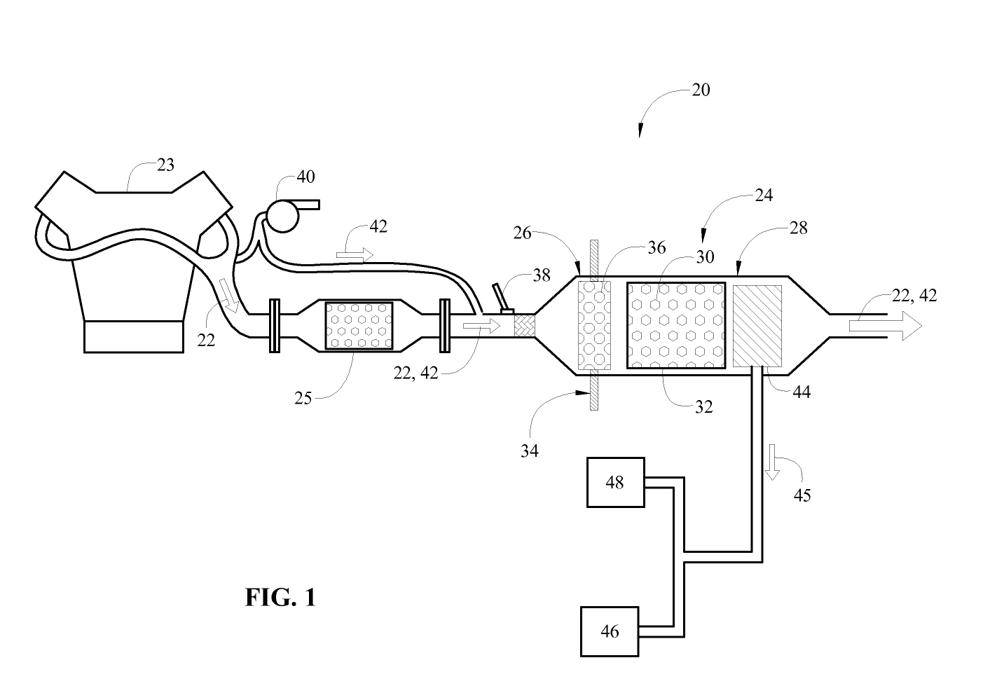

Referring to FIG. 1, wherein like numerals indicate like parts throughout the several views, an exhaust gas treatment system is shown generally at 20. The treatment system 20 treats a flow of exhaust gas, indicated by arrow 22, from an Internal combustion engine 23 (ICE) to reduce the toxicity of the exhaust gas, i.e., to reduce toxic emissions of the exhaust gas, including but not limited to, nitrogen oxides (NO), carbon monoxide (CO) and/or hydrocarbons (HC).

The exhaust gas treatment system 20 includes a close coupled catalytic converter 25 that is disposed in close proximity to the internal combustion engine 23, typically within an engine compartment of the vehicle. Once activated, the close coupled catalytic converter 25 provides the majority of the exothermic reactions necessary to treat the exhaust gas from the internal combustion engine 23. The exhaust gas treatment system 20 further includes an underfloor catalytic converter 24. The underfloor catalytic converter 24 is disposed downstream of the engine. The close coupled catalytic converter and the underfloor catalytic converter 24 may each include, but are not limited to, a three way catalytic converter. The three way catalytic converter may include Platinum Group Metals (PGM), and converts a percentage of the nitrogen oxides in the exhaust gas into nitrogen and carbon dioxide or water, as well as oxidizes a percentage of the carbon monoxide to carbon dioxide and oxidizes a percentage of the unburnt hydrocarbons to carbon dioxide and water.

The underfloor catalytic converter 24 includes an upstream portion 26 and a downstream portion 28. The downstream portion 28 includes a underfloor catalyst 30 for treating the exhaust gas as described above. An underfloor catalyst core 32 is disposed within the downstream portion 28, and supports the underfloor catalyst 30.

The exhaust gas treatment system 20 further includes a heating module 34. The heating module 34 is disposed within the upstream portion 26 of the underfloor catalytic converter 24, upstream of the underfloor catalyst 30. The heating module 34 heats the exhaust gas prior to the exhaust gas entering the underfloor catalyst 30 in the downstream portion 28 of the underfloor catalytic converter 24. The heating module 34 may be heated through resistance heating. Accordingly, an electric current may be applied to the heating module 34, with the resistance of the heating module 34 generating heat. It should be appreciated that the heating module 34 may be heated in some other manner not shown or described herein. The heating module 34 may further include an electrically heated catalyst 36 disposed thereon. The electrically heated catalyst 36 may include but is not limited to a three way catalytic converter. The three way catalytic converter may include Platinum Group Metals (PGM), and converts a percentage of the nitrogen oxides in the exhaust gas into nitrogen and carbon dioxide or water, as well as oxidizes a percentage of the carbon monoxide to carbon dioxide and oxidizes a percentage of the unburnt hydrocarbons to carbon dioxide and water. The heat generated from the resistance heating of the heating module 34 is used to heat the electrically heated catalyst 36 to the pre-determined temperature, which may include but is not limited to the light-off temperature of the electrically heated catalyst 36.

The exhaust gas treatment system 20 further includes a hydrocarbon injector 38. The hydrocarbon injector 38 is disposed upstream of the heating module 34, and injects hydrocarbons, including but not limited to gasoline or diesel fuel, into the flow of exhaust gas from the internal combustion engine 23. The injected hydrocarbons combust within the exhaust gas treatment system 20 upstream of the underfloor catalyst 30, thereby generating heat and increasing the temperature of the flow of exhaust gas. The heat added through combustion of the injected hydrocarbons assists in heating the electrically heated catalyst and the underfloor catalyst 30 to the light-off temperature.

The exhaust gas treatment system 20 further includes an air pump 40. The air pump 40 is in fluid communication with the exhaust gas treatment system 20, and when activated, provides a flow of air, generally indicated by arrow 42, to the exhaust gas treatment system 20. The air pump 40 may include any suitable style, size, and/or configuration of air pump 40, and may be powered in any suitable manner, including but not limited through electrical power.

The exhaust gas treatment system 20 further includes an exhaust gas heat recovery unit 44. The exhaust gas heat recovery unit 44 is disposed downstream of the underfloor catalyst 30 in the underfloor catalytic converter 24. The exhaust gas heat recovery unit 44 may include any heat exchanger suitable for use in the exhaust gas treatment system 20 and capable of absorbing, i.e., recovering, heat from air and/or exhaust gas flowing through the underfloor catalytic converter 24 and transferring the absorbed heat, generally indicated by arrow 45, to another vehicle system, such as but not limited to a cabin heating system 46 and/or a drivetrain transmission system 48 described below.

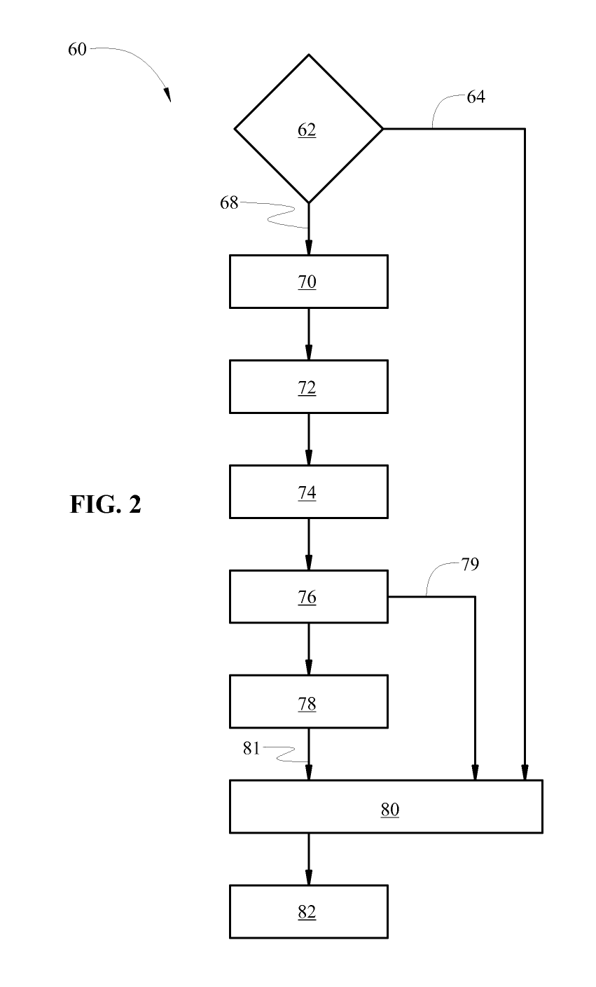

Referring to FIG. 2, a method of operating a hybrid vehicle and more specifically a method of heating a vehicle system with thermal energy from the exhaust gas treatment system 20 is provided and generally shown at 60. The vehicle system heated with the thermal energy from the exhaust gas treatment system 20 may include but is not limited to the cabin heating system 46 or the drivetrain transmission system 48. More specifically, thermal energy from the exhaust gas treatment system 20 may be used to heat an engine coolant, which is used by the cabin heating system 46. Similarly, the thermal energy from the exhaust gas treatment system 20 may be used to heat a transmission fluid, e.g., oil, which is used by an automatic transmission of the hybrid vehicle.

The method includes determining if the internal combustion engine 23 is running or if the internal combustion engine 23 is not running, generally indicated by block 62. If the internal combustion engine 23 is running to otherwise power the vehicle and/or charge a battery of the hybrid vehicle, generally indicated at 64, then heat within the exhaust gas from the internal combustion engine 23 may be recovered through the exhaust gas recovery unit, generally indicated by block 80, and transferred to the other vehicle systems, generally indicated by block 82, as needed to improve efficiency of the vehicle. However, because operation of the internal combustion engine 23 of hybrid vehicles is not constantly required, the vehicle may currently be operating without the internal combustion engine 23, i.e., with the internal combustion engine 23 not running. When the internal combustion engine 23 is not running to otherwise power the vehicle, generally indicated at 68, then exhaust gas from the internal combustion engine 23 is not present and heat may not be recovered therefrom for the other vehicle systems.

Accordingly, in order to provide thermal energy, i.e., heat, to the other vehicle systems when the internal combustion engine 23 is not running, such as the cabin heating system 46 and/or the drivetrain transmission system 48, the method includes heating the electrically heated catalyst 36 with the heating module 34, generally indicated by block 70, to the pre-determined temperature when the internal combustion engine 23 is not running. As noted above, the pre-determined temperature may include but is not limited to a light-off temperature of the catalyst. The light-off temperature may include but is not limited to a temperature of at least two hundred degrees Celsius (200° C.). As noted above, the heating module 34 and the electrically heated catalyst 36 may be heated in any appropriate manner, such as through an electrical current applied to the heating module 34. Once the electrically heated catalyst 36 is heated to the light-off temperature, the internal combustion engine 23 may be started, with the exhaust gas treated by the electrically heated catalyst. As such, initial treatment of the exhaust gas 22 is performed by the electrically heated catalyst 36 while the close coupled catalytic converter 25 and the underfloor catalyst 30 are heated to their respective light-off temperatures by the exhaust gas 22.

After the electrically heated catalyst 36 is heated to the light-off temperature, a flow of air is pumped through the exhaust gas treatment system 20. Heat is transferred from the heating module 34 and/or the electrically heated catalyst to the flow of air as the flow of air passes across and/or through the heating module 34 and the electrically heated catalyst 36. When the internal combustion engine 23 is not running, the flow of air is supplied by the air pump 40. As such, the method includes activating the air pump 40, generally indicated by block 72, to supply the flow of air when the internal combustion engine 23 is not running. It should be appreciated that the heating module 34 may also be used to add heat to the flow of exhaust gas when the internal combustion engine 23 is running to further heat the exhaust gas to decrease the amount of time to heat the underfloor catalyst 30 to the light-off temperature, and to provide additional heat for the exhaust gas heat recovery unit 44.

Once the air pump 40 is activated and supplying the flow of air through the exhaust gas treatment system 20, then the method further includes injecting hydrocarbons into the flow of air, generally indicated by block 74. The hydrocarbons are injected by the hydrocarbon injector 38 after the electrically heated catalyst 36 is heated to the pre-defined temperature to form a hydrocarbon/air mixture. The hydrocarbon/air mixture combusts upstream of the underfloor catalyst 30 to further heat the flow of air when the internal combustion engine 23 is not running. It should be appreciated that the hydrocarbon injector 38 may also be used to inject hydrocarbons into the flow of exhaust gas when the internal combustion engine 23 is running to further heat the exhaust gas to decrease the amount of time to heat the underfloor catalyst 30 to the light-off temperature, and to provide additional heat for the exhaust gas heat recovery unit 44.

The method may further include heating the underfloor catalyst 30, generally indicated by block 76, to the light-off temperature. The light-off temperature of the underfloor catalyst may include a temperature of at least two hundred degrees Celsius (200° C.). The underfloor catalyst 30 may be heated to the light-off temperature prior to starting the internal combustion engine 23 so that the underfloor catalyst 30 is immediately ready to react with the emissions from the internal combustion engine 23 upon starting, thereby minimizing emissions that may otherwise pass through the exhaust gas treatment system 20 prior to the underfloor catalyst 30 reaching the light-off temperature. Once the underfloor catalyst 30 has reached the light-off temperature, then the method may include starting the internal combustion engine 23, generally indicated by block 78. Otherwise, the internal combustion engine 23 may be started prior to the underfloor catalyst 30 being heated to the light-off temperature, but after the electrically heated catalyst 36 being heated to the pre-determined temperature.

The method further includes recovering thermal energy from the flow of air downstream of the underfloor catalyst 30 with the exhaust gas heat recovery system, generally indicated by block 80. The thermal energy may be recovered before and/or after the underfloor catalyst 30 is fully heated to the light-off temperature. Furthermore, the thermal energy may be recovered before the internal combustion engine is started, generally indicated at 79, or after the internal combustion engine 23 is started, generally indicated at 81. The recovered thermal energy may then be transferred to one or more vehicle systems, generally indicated by block 82, to provide heat to the vehicle systems. As described above, the vehicle systems may include but are not limited to the cabin heating system 46 and the drivetrain transmission system 48. As such, the recovered thermal energy may be transferred to the engine coolant to provide heat to the cabin heating system 46, or may be transferred to the transmission fluid to provide heat thereto. By heating the engine coolant with the recovered thermal energy from the exhaust gas treatment system 20, the internal combustion engine 23 need not be started to warm the engine coolant when the internal combustion engine 23 is not otherwise needed to operate the hybrid vehicle, thereby minimizing fuel consumption. By heating the transmission fluid with the recovered thermal energy from the exhaust gas treatment system 20, energy losses within the transmission may be reduced, thereby increasing the efficiency of the vehicle.

The exhaust gas treatment system 20 may continue to operate as described above with the internal combustion engine 23 not running to continue to provide thermal energy to the other vehicle systems. As such, the treatment system 20 may continue to heat the heating electrically heated catalyst 36 with the heating module 34, operate the air pump 40 to supply the flow of air through the treatment system 20, and inject the hydrocarbons into the flow of air. Heat from the heating core 36 and generated through combustion of the hydrocarbons may therefore continue to be recovered by the exhaust gas treatment system 20 and transferred to the other vehicle systems as described above. Alternatively, the treatment system 20 may continue to operate in much the same manner after the internal combustion engine 23 is started. As such, the method may include continuing to heat the heating module 34 after the internal combustion engine 23 is started; continuing to inject hydrocarbons into the flow of air to form the hydrocarbon/air mixture after the internal combustion engine 23 is started; continuing to combust the hydrocarbon/air mixture upstream of the underfloor catalyst 30 to heat a flow of exhaust gas from the internal combustion engine 23 after the internal combustion engine 23 is started; continuing to recover thermal energy from the flow of exhaust gas downstream of the underfloor catalyst 30 with the exhaust gas heat recovery system after the internal combustion engine 23 is started; and continuing to transfer the recovered thermal energy to the engine coolant of the cabin heating system 46 or the transmission fluid of the drivetrain transmission system 48 after the internal combustion engine 23 is started. However, once the internal combustion engine 23 is started, then the air pump 40 is not required to supply the flow of air, and the heat from the heating core 36 and through combustion of the hydrocarbons may be added to the flow of exhaust gas from the internal combustion engine 23.

While the best modes for carrying out the invention have been described in detail, those familiar with the art to which this invention relates will recognize various alternative designs and embodiments for practicing the invention within the scope of the appended claims.

1. A method of heating a vehicle system with thermal energy from an exhaust gas treatment system for an internal combustion engine, the method comprising:
heating an electrically heated catalyst with a heating module to a pre-determined temperature;
pumping a flow of air through the exhaust gas treatment system after the electrically heated catalyst is heated to the pre-defined temperature to transfer heat from the heating module to the flow of air;
injecting hydrocarbons into the flow of air after the electrically heated catalyst is heated to the pre-defined temperature to form a hydrocarbon/air mixture;
combusting the hydrocarbon/air mixture upstream of a underfloor catalyst to heat the flow of air;
recovering thermal energy from the flow of air downstream of the underfloor catalyst with an exhaust gas heat recovery system; and
transferring the recovered thermal energy to a vehicle system to provide heat to the vehicle system.

2. A method as set forth in claim 1 wherein transferring the recovered thermal energy to the vehicle system is further defined as transferring the recovered thermal energy to at least one of a cabin heating system or a drivetrain transmission system.

3. A method as set forth in claim 2 wherein transferring the recovered thermal energy to at least one of a cabin heating system or a drivetrain transmission system includes transferring the recovered thermal energy to an engine coolant of the cabin heating system or a transmission fluid of the drivetrain transmission system.

4. A method as set forth in claim 1 further comprising heating the underfloor catalyst to a light-off temperature prior to recovering the thermal energy.

5. A method as set forth in claim 4 wherein heating the underfloor catalyst to the light-off temperature is further defined as heating the underfloor catalyst to a temperature of at least two hundred degrees Celsius (200° C.).

6. A method as set forth in claim 1 further comprising determining if the internal combustion engine is running or if the internal combustion engine is not running.

7. A method as set forth in claim 5 further comprising activating an air pump to supply the flow of air when the internal combustion engine is not running.

8. A method as set forth in claim 6 further comprising starting the internal combustion engine after the underfloor catalyst is heated to the light-off temperature.

9. A method as set forth in claim 1 wherein heating the electrically heated catalyst to a pre-determined temperature is further defined as heating the electrically heated catalyst to a temperature of at least two hundred degrees Celsius (200° C.).

10. A method of operating a hybrid vehicle, the method comprising:
determining if an internal combustion engine of the hybrid vehicle is running or if the internal combustion engine is not running;
heating an electrically heated catalyst with a heating module of an exhaust gas treatment system to a pre-determined temperature when the internal combustion engine is not running;
pumping a flow of air through the exhaust gas treatment system with an air pump after the electrically heated catalyst is heated to the pre-defined temperature to transfer heat from the heating module to the flow of air when the internal combustion engine is not running;
injecting hydrocarbons into the flow of air after the electrically heated catalyst is heated to the pre-defined temperature to form a hydrocarbon/air mixture when the internal combustion engine is not running;
combusting the hydrocarbon/air mixture upstream of an underfloor catalyst of the exhaust gas treatment system to heat the flow of air when the internal combustion engine is not running;
recovering thermal energy from the flow of air downstream of the underfloor catalyst with an exhaust gas heat recovery system; and
transferring the recovered thermal energy to an engine coolant of a cabin heating system or a transmission fluid of a drivetrain transmission system.

11. A method as set forth in claim 10 further comprising heating the underfloor catalyst to a light-off temperature.

12. A method as set forth in claim 11 further comprising starting the internal combustion engine after the underfloor catalyst is heated to the light-off temperature.

13. A method as set forth in claim 12 further comprising continuing to:
heat the heating module after the internal combustion engine is started;
inject hydrocarbons into the flow of air to form the hydrocarbon/air mixture after the internal combustion engine is started;
combust the hydrocarbon/air mixture upstream of the underfloor catalyst to heat a flow of exhaust gas from the internal combustion engine after the internal combustion engine is started;
recover thermal energy from the flow of exhaust gas downstream of the underfloor catalyst with the exhaust gas heat recovery system after the internal combustion engine is started; and
transfer the recovered thermal energy to the engine coolant of the cabin heating system or the transmission fluid of the drivetrain transmission system after the internal combustion engine is started.

14. A method as set forth in claim 13 wherein heating the electrically heated catalyst to a pre-determined temperature is further defined as heating the electrically heated catalyst to a temperature of at least two hundred degrees Celsius (200° C.).

15. A method as set forth in claim 13 wherein heating the underfloor catalyst to the light-off temperature is further defined as heating the underfloor catalyst to a temperature of at least two hundred degrees Celsius (200° C.).
